(19) United States
(12) Patent Application Publication
(10) Pub. No.: US 2026/0225400 A1
(43) Pub. Date: Aug. 6, 2026

(54) VEHICLE KNUCKLE ASSEMBLY WITH BEARING ASSEMBLY BUMP GUARD

(71) Applicant: ILJIN USA Corporation, Novi, MI (US)

(72) Inventors: Benjamin Cooley, Ypsilanti, MI (US); Zach Gustitus, Farmington Hills, MI (US); Richard Haehn, Bloomfield Hills, MI (US); Robert Sutherlin, Farmington Hills, MI (US)

(73) Assignee: ILJIN USA Corporation, Novi, MI (US)

(21) Appl. No.: 19/027,954

(22) Filed: Jan. 17, 2025

(51) Int. Cl. B60B 27/02; B60B 27/00; F16C 33/66

(52) U.S. Cl. CPC B60B 27/02; B60B 27/0073; F16C 33/6607; B60B 2900/511

(57) ABSTRACT

A vehicle includes a vehicle body and a knuckle assembly connected to the vehicle body. The knuckle assembly includes a knuckle and a bearing assembly supported by the knuckle. The bearing assembly includes a rotatable hub, a wheel end, and a knuckle end opposite the wheel end. The bearing assembly includes a grease cap fixed at the knuckle end. The bearing assembly includes a bump guard fixed to the grease cap opposite the rotatable hub.

### TECHNICAL FIELD

The present specification generally relates to a knuckle assembly for coupling a wheel to a vehicle and, more specifically, a knuckle assembly for coupling a wheel to a vehicle that has increased robustness and/or cost efficiencies, e.g., relative to conventional designs.

### BACKGROUND

Vehicles typically include knuckle assemblies for supporting and controlling orientation of wheels of the vehicle relative to a vehicle body. Knuckle assemblies typically include bearing assemblies or the like to allow rotation of the wheel relative to the vehicle body. During operation, debris, such as gravel, may interfere with and/or damage the bearing assemblies or other structure of the assembly.

Accordingly, a need exists for an improved knuckle assembly for coupling a wheel to a vehicle that has increased robustness and/or cost efficiencies, e.g., relative to conventional designs.

### SUMMARY

In one embodiment, a vehicle includes a vehicle body and a knuckle assembly connected to the vehicle body. The knuckle assembly includes a knuckle and a bearing assembly supported by the knuckle. The bearing assembly includes a rotatable hub, a wheel end, and a knuckle end opposite the wheel end. The bearing assembly includes a grease cap fixed at the knuckle end. The bearing assembly includes a bump guard fixed to the grease cap opposite the rotatable hub.

In another embodiment, a knuckle assembly for a vehicle includes a knuckle and a bearing assembly supported by the knuckle. The bearing assembly includes a rotatable hub, a wheel end, and a knuckle end opposite the wheel end. The bearing assembly includes a grease cap fixed at the knuckle end. The bearing assembly includes a bump guard fixed to the grease cap opposite the rotatable hub.

In another embodiment, a bearing assembly for a vehicle knuckle assembly includes a rotatable hub, a wheel end, and a knuckle end opposite the wheel end. The bearing assembly includes a grease cap fixed at the knuckle end. The bearing assembly includes a bump guard fixed to the grease cap opposite the rotatable hub.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vehicle having a knuckle assembly according to one or more embodiments shown and described herein;

FIG. 2 schematically depicts a partial exploded view of the knuckle assembly that includes a knuckle and a bearing assembly according to one or more embodiments shown and described herein;

FIG. 3 schematically depicts a cross-section view of the knuckle assembly includes the knuckle and the bearing assembly according to one or more embodiments shown and described herein;

FIG. 4 schematically depicts an exploded view of the bearing assembly according to one or more embodiments shown and described herein;

FIG. 5 schematically depicts a cross-section view of a bump guard and a seal of the bearing assembly abutting the knuckle according to one embodiment shown and described herein; and

FIG. 6 schematically depicts a cross-section view of another bump guard and another seal of the bearing assembly abutting the knuckle according to another embodiment shown and described herein.

### DETAILED DESCRIPTION

Described herein is a knuckle assembly that can be connected to a vehicle. The knuckle assembly includes a knuckle and a bearing assembly supported by the knuckle. The bearing assembly includes a rotatable hub, a grease cap, and a bump guard fixed to the grease cap opposite the hub. The bump guard protects the grease cap and other components of the bearing assembly, e.g., to prevent deformation of the grease cap from pebbles or other objects during operation of the vehicle. Various embodiments of vehicle and the knuckle assembly are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components, unless the context clearly indicates otherwise.

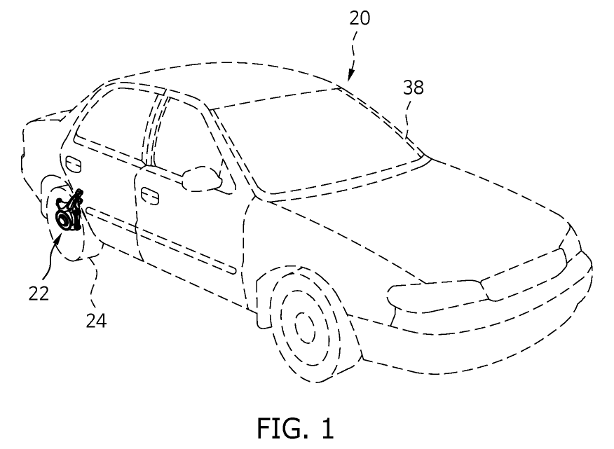

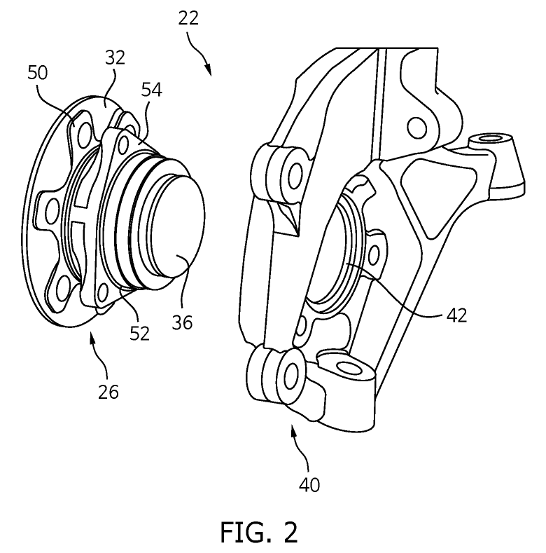

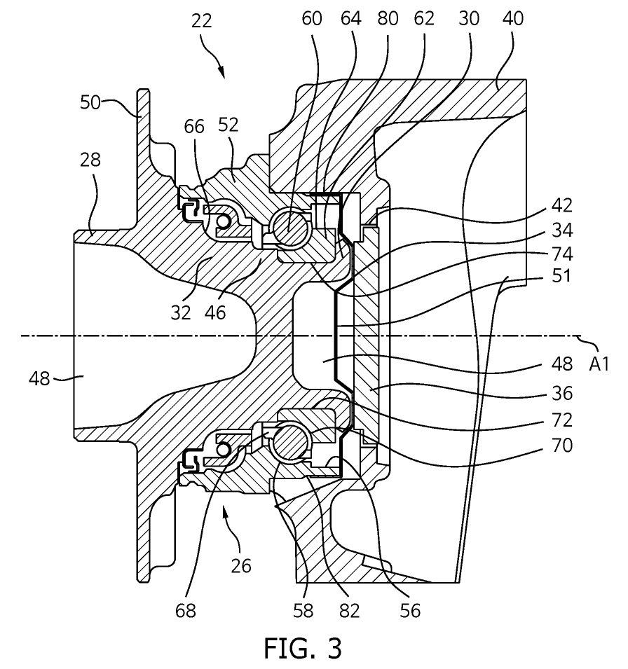

Referring now to FIG. 1, a vehicle 20 having a knuckle assembly 22 for coupling a wheel 24 to the vehicle 20 is illustrated according to one or more embodiments described herein. The knuckle assembly 22, schematically depicted in FIGS. 2-4, may generally include a knuckle 40 and a bearing assembly 26 supported by the knuckle 40. The bearing assembly 26 has a wheel end 28 and a knuckle end 30 opposite the wheel end 28. The knuckle assembly 22 has a rotatable hub 32 supported by the bearing assembly 26. The bearing assembly 26 has a grease cap 34 fixed at the knuckle end 30 of the bearing assembly 26. The bearing assembly 26 has a bump guard 36 fixed to the grease cap 34 opposite the hub 32.

The vehicle 20 may be any suitable type of automobile, e.g., a passenger or commercial automobile such as a sedan, a coupe, a truck, a sport utility, a crossover, a van, a minivan, a taxi, a bus, etc. The knuckle assembly 22 permits rotation of the wheel 24, e.g., relative to a vehicle body 38 of the vehicle 20. The vehicle body 38 may define a passenger compartment to house occupants, if any, of the vehicle 20.

The vehicle 20 may be of a unibody construction in which a vehicle frame is unitary with the vehicle body 38 (including frame rails, pillars, roof rails, etc.). As another example, the vehicle 20 may have a body-on-frame construction (also referred to as a cab-on-frame construction) in which the vehicle body 38 and vehicle frame are separate components, i.e., are modular, and the vehicle body 38 is supported on and affixed to the vehicle frame. Alternatively, the vehicle frame and vehicle body 38 may have any suitable construction. The vehicle frame and vehicle body 38 may be of any suitable material, for example, steel, aluminum, and/or fiber-reinforced plastic, etc.

The knuckle 40 of the knuckle assemblies 22 is included in the vehicle 20 to enable attachment of the wheels 24 to the vehicle 20. The knuckle assembly 22 is connected to the vehicle body 38, e.g., via a suspension system (not shown) of the vehicle 20. The suspension system may allow vertical movement of the knuckle assembly 22 and the wheel 24 relative to the vehicle body 38. The suspension system may include, for example, shocks, struts, springs, dampeners, and/or other structure for controlling movement of the knuckle 40 relative to the vehicle body 38. The wheel 24 may be connected to the knuckle assembly 22, e.g., the wheel 24 may be connected to the rotatable hub 32 of the knuckle assembly 22 and with lug nuts, bolts, or other suitable structure.

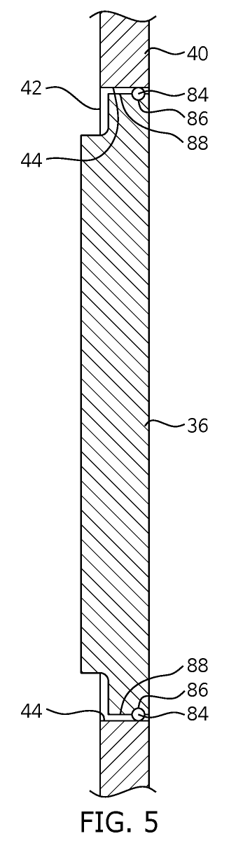

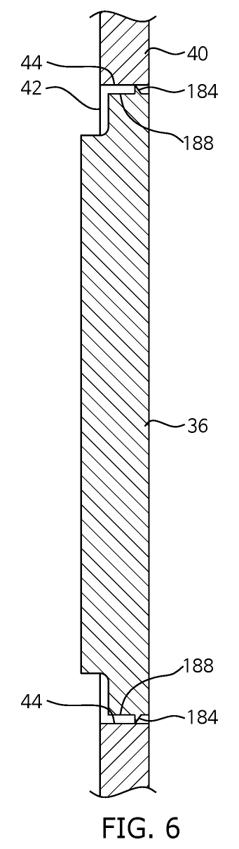

The knuckle assembly 22 may include a knuckle 40. The knuckle 40 is included in the knuckle assembly 22 to enable attachment of the knuckle assembly 22 to other components of the vehicle 20, e.g., to the suspension system. The knuckle 40 may aid in controlling an orientation of the wheel 24. For example the knuckle 40 may maintain a caster and/or camber of the wheel 24, e.g., as the suspension system permits vertical motion of the wheel 24. As another example, the knuckle 40 may be operatively coupled to a steering system (not shown) of the vehicle 20 such that force generated by the steering system changes a steering direction of the wheel 24. The knuckle 40 may include a bore 42. The bore 42 may provide access, e.g., to install and/or remove the hub 32. The bore 42 may provide access, e.g., for a driveshaft to engage with a bearing assembly when the knuckle 40 is used in an all-wheel drive vehicle and the hub 32 is driven with power from a powertrain from the all-wheel drive vehicle. The bore 42 may extend completely through the knuckle 40, e.g., from one open distal end to an opposite open distal end of the bore 42. The bore 42 may include an inner surface 44 (see FIGS. 5 and 6) that faces radially inward.

The rotatable hub 32 is included to enable mounting of the wheel 24 to the vehicle 20. The hub 32 may include a shaft 46 that extends along an axis A1. The shaft 46 may include one or more recesses 48, e.g., to reduce mass of the hub 32. The recesses 48 may be at opposing distal ends of the shaft 46. The recesses 48 may extend axially inward, e.g., toward each other. The hub 32 may include a hub flange 50. The hub flange 50 may be configured to couple to the wheel 24. For example, the hub flange 50 may include openings, e.g., to receive lug bolts for fixing the wheel 24 to the hub 32. The hub flange 50 may include other structures to couple the wheel 24 to the hub 32.

The hub 32 may be non-driven such that torque from a powertrain (not shown) of the vehicle 20 is not transmitted to the wheel 24 fixed to the hub 32. In other words, the hub 32 may be free from being operatively coupled to a drive axle, internal combustion engine, electric motor, and/or other torque generation or transmitting component of the powertrain. For example, the vehicle 20 may be a front-wheel drive vehicle and the hub 32 may support a rear wheel. As another example, the vehicle 20 may be a rear-wheel drive vehicle and the hub 32 may support a front wheel.

The knuckle assembly 22 includes the bearing assembly 26 to enable rotation of the wheel 24 relative to the vehicle body 38. The bearing assembly 26 may be supported by the knuckle 40, e.g., fixed to the knuckle 40 via fasteners, weld, or other suitable structure. The hub 32 may be rotatably supported by the bearing assembly 26. For example, the bearing assembly 26 may surround and support the hub 32 between the knuckle 40 and the hub 32. The bearing assembly 26 may permit rotational movement of the hub 32 and inhibit axial and radial movement of the hub 32, e.g., relative to the knuckle 40 and the axis A1 of the hub 32. The bearing assembly 26 includes the wheel end 28 at which the wheel 24 may be connected. The knuckle end 30 is opposite the wheel end 28. The wheel end 28 and the knuckle end 30 may be spaced from each other along the axis A1 and at opposing distal ends of the bearing assembly 26. The knuckle end 30 may be vehicle inboard of the wheel end 28.

The bearing assembly 26 may include an outer ring 52. The outer ring 52 is included in the bearing assembly 26 to enable the bearing assembly 26 to be attached to another structure of the knuckle assembly 22 and/or the vehicle 20. The outer ring 52 may include an outer ring flange 54 which may be coupled to, e.g., the knuckle 40, vehicle suspension structure, vehicle steering structure etc. The outer ring flange 54 which may be coupled by one or more securing elements (e.g., studs, bolts, or the like). The outer ring 52 has a circular inner surface 56 facing a radially inward direction, e.g., relative to the axis A1. The circular inner surface 56 may include one or more circumferential raceways 58. The raceways 58 guide movement of bearings 60 of the bearing assembly 26. The raceways 58 may direct travel of the bearings 60, e.g., to allow movement of the bearings 60 circumferentially along the circular inner surface 56 while limiting movement of the bearings 60 axially along the circular inner surface 56.

The bearings 60 of the bearing assembly 26 are provided to enable free rotation, e.g., of the hub 32, an inner ring 62 of the bearing assembly 26, or other structure, relative to the outer ring 52 of the bearing assembly 26. The bearings 60 may be circumferentially arranged, e.g., along the circular inner surface 56 of the outer ring 52, along a circular outer surface 64 of the inner ring 62, and/or along a circular outer surface 66 of the hub 32. In the example provided, the bearings 60 are ball bearings. However, it is to be understood that the bearings 60 could be roller bearings, needle bearings, tapered roller bearings, or any suitable type. One or more retaining rings 68, such as bearing cages, may be included to maintain positions of the bearings 60 relative to each other.

The inner ring 62 of the bearing assembly 26 is included to couple the bearing assembly 26 with the hub 32. The inner ring 62 is radially inward of the outer ring 52, e.g., with bearings 60 there between. The inner ring 62 may further control of movement of the hub 32. For example, the circular outer surface 64 of the inner ring 62 may include a raceway 70 that permits circumferential movement of the bearings 60 along the outer surface 64 of the inner ring 62 and inhibit axial movement. A circular inner surface 72 of the inner ring 62 may circumferentially abut the shaft 46 of the hub 32, e.g., inhibiting radial movement of the bearing assembly 26 relative to the hub 32. The inner ring 62 may be disposed with a circumferential channel 74 of the shaft 46, e.g., inhibiting axial movement of the bearing assembly 26 relative to the hub 32. The circular inner surface 56 of the outer ring 52, the outer surface 64 of the inner ring 62, the raceways 58, 70, the shaft 46 of the hub 32, the hub flange 50, the arrangement of the bearings 60, and the bore 42 of the knuckle 40 may all be concentric, e.g., about the axis A1.

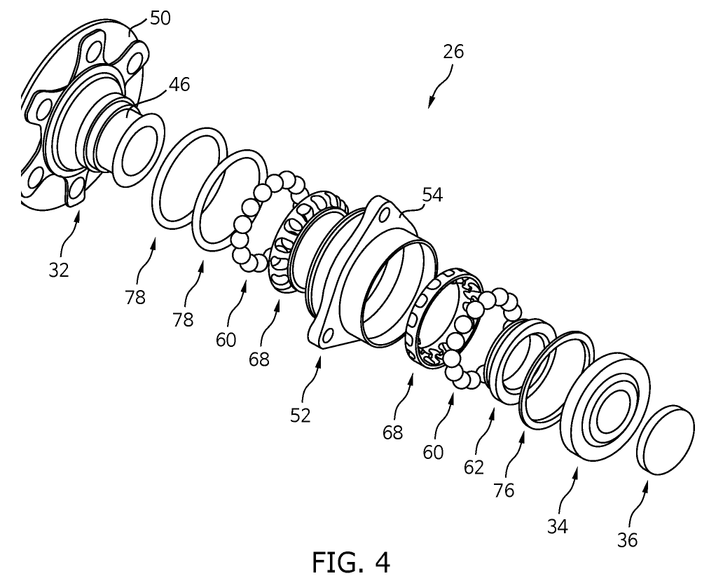

Bearing assembly 26 may include one or more seals 76, 78 (see FIG. 4). For example, one seal 76 may be located at the knuckle end 30 and another seal 78 may be located at wheel end 28. The seals 76, 78 may be barrier seals, e.g., O-rings, gasket seals, etc., that block material from moving there past. The seals 76, 78 may be labyrinth seals that include one or more structures to define a tortuous path that is difficult for material to travel through, e.g., when subject to normal operational forces.

The knuckle assembly 22 includes the grease cap 34, e.g., to maintain grease and/or other lubricating fluid within the bearing assembly 26 and/or to protect components of the bearing assembly 26. For example, the grease cap 34 may inhibit pebbles, gravel, dirt, or other debris from coming into contact with the bearings 60, the raceways 58, 70, the hub 32 shaft 46, etc.

The grease cap 34 is spaced from the hub 32. For example, a center portion 51 of the grease cap 34 may extend across the recess 48 at the knuckle end 30 of the bearing assembly 26. The center portion 51 of the grease cap 34 may be spaced from a distal end of the shaft 46 of the hub 32 along the axis A1, i.e., with a gap there between. Spacing the grease cap 34 from the hub 32 allows the hub 32 to rotate relative to the grease cap 34. In other words, the grease cap 34 may remain fixed and the hub 32 may rotate, e.g., relative to the knuckle 40.

The grease cap 34 may be fixed to the bearing assembly 26, e.g., fixed at the knuckle end 30 of the bearing assembly 26. More specifically, the grease cap 34 may be fixed to the outer ring 52 of the bearing assembly 26. For example, an outer periphery 80 of the grease cap 34 may axially extend from the center portion 51 and be press fit on to, and around, an outer surface 82 of the outer ring 52 at the knuckle end 30. As another example, the outer periphery 80 of the grease cap may axially extend from the center portion 51 and be press fit into, and circumferentially along, an inner surface of the outer ring 52 at the knuckle end 30 (not shown). Additionally or alternately, the grease cap 34 may be fixed to the bearing assembly 26 with a fastener, weld, adhesive, or other suitable structure. The grease cap 34 may be steel, aluminum, or any suitable material, e.g., material that is sufficiently plastically deformable to permit the grease cap 34 to be press fit around the outer surface 82 of the outer ring 52.

The knuckle assembly 22 includes the bump guard 36 to protect the grease cap 34, e.g., from pebbles or other road debris that may impact the bump guard 36. The bump guard 36 may be a circular disc. In other words, the bump guard 36 may have an outer perimeter that is generally circular. The bump guard 36 may be of a material that is better able to withstand impact than the material forming the grease cap 34, e.g., such that the bump guard 36 is less prone to permanent deformation than the grease cap 34. The bump guard 36 may be a non-metallic material. For example, the bump guard 36 may be a rigid plastic, such as, polypropylene, polyurethane, acrylonitrile butadiene styrene (ABS), polycarbonate, thermoplastic olefin (TPO), high impact polystyrene (HIPS), high molecular weight polyethylene (HMWPE), or the like. As another example, the bump guard 36 may be a metallic material that is more stronger, i.e., stiffer, than the grease cap 34.

The bump guard 36 is fixed to the grease cap 34, e.g., with a heat activated bond (such as a heat-activated adhesive), an adhesive (such as a urethane, polyurethane, or epoxy adhesive) and/or other suitable structure and methods. The bump guard 36 is fixed to the grease cap 34 opposite the hub 32. In other words, the grease cap 34 may be between the hub 32 and the bump guard 36 along the axis A1. The bump guard 36 may be disposed in the bore 42. In other words, the bore 42 may surround the bump guard 36 with the bump guard 36 between the open ends of the bore 42 along the axis A1.

With reference to FIGS. 5 and 6, the knuckle assembly 22 may include a seal 84, 184 for inhibiting movement of debris through the bore 42 past the bump guard 36 and toward the grease cap 34. The seal 84, 184 may extend radially outward from the bump guard 36 to the radially inward facing inner surface 44 of the bore 42. The seal 84, 184 may abut the bore 42, e.g., circumferentially along the inner surface 44.

With reference to FIG. 5, the bump guard 36 may include a channel 86, e.g., extending circumferentially about a radially outward facing surface 88 at the perimeter of the bump guard 36. The seal 84 may be engaged with the channel 86. For example, the seal 84 may be a ring seal disposed in the channel 86 and may extend circumferentially about the perimeter of the bump guard 36. The seal 84 may extend radially away from bump guard 36, e.g., beyond the radially outward facing surface 88. The seal 84 may be rubber, silicone, or any suitable material.

With reference to FIG. 6, the bump guard 36 and the seal 184 may be monolithic with the seal 184 extending radially outward from a radially outward facing surface 88 at the perimeter of the bump guard 36, i.e., toward the inner surface 44 of the bore 42. For the purposes of this disclosure, “monolithic” means a single-piece unit, i.e., a continuous piece of material without any fasteners, joints, welding, adhesives, etc., fixing multiple pieces to each other. For example, the bump guard 36 and the seal 184 may be formed in a common injection mold operation, 3-D printed in a same operation, etc. The seal 184 and the bump guard 36 may be a same material.

In some embodiments, the bump guard 36 may have a flat outwardly facing surface without the seal 84 or 184. The bump guard 36 is in direct contact with the knuckle 40 and is combined with a press-fit. That is, the radially outward facing surface 88 is in direct contact with the inner surface 44 of the bore 42.

From the above, it is to be appreciated that defined herein is a vehicle with a knuckle assembly that includes a bearing assembly having a grease cap and a bump guard fixed to the grease cap, the bump guard protecting the grease cap.

It is noted that the terms "generally" and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A vehicle, comprising:
a vehicle body; and
a knuckle assembly connected to the vehicle body, the knuckle assembly including:
a knuckle; and
a bearing assembly supported by the knuckle, the bearing assembly including:
a rotatable hub;
a wheel end;
a knuckle end opposite the wheel end;
a grease cap fixed at the knuckle end; and
a bump guard fixed to the grease cap opposite the rotatable hub.

2. The vehicle of claim 1, further comprising a wheel connected to the rotatable hub.

3. The vehicle of claim 1, wherein the rotatable hub is non-driven.

4. The vehicle of claim 1, wherein the knuckle has a bore, and the bump guard is disposed in the bore.

5. The vehicle of claim 4, wherein the bump guard includes a channel, and further comprising a seal engaged with the channel, and wherein the seal abuts the bore.

6. The vehicle of claim 4, wherein the bump guard includes a seal extending radially outward from a circumference of the bump guard, the bump guard and the seal being monolithic, and wherein the seal abuts the bore.

7. A knuckle assembly for a vehicle, the knuckle assembly comprising:
a knuckle; and
a bearing assembly supported by the knuckle, the bearing assembly including:
a rotatable hub;
a wheel end;
a knuckle end opposite the wheel end;
a grease cap fixed at the knuckle end; and
a bump guard fixed to the grease cap opposite the rotatable hub.

8. The knuckle assembly of claim 7, wherein the knuckle has a bore, and the bump guard is disposed in the bore.

9. The knuckle assembly of claim 8, wherein the knuckle assembly includes a seal extending radially outward from the bump guard to a radially inward facing surface of the bore.

10. The knuckle assembly of claim 9, wherein the bump guard includes a channel, and wherein the seal is engaged with the channel.

11. The knuckle assembly of claim 9, wherein the bump guard and the seal are monolithic.

12. A bearing assembly for a vehicle knuckle assembly, the bearing assembly comprising:
a rotatable hub;
a wheel end;
a knuckle end opposite the wheel end;
a grease cap fixed at the knuckle end; and
a bump guard fixed to the grease cap opposite the rotatable hub.

13. The bearing assembly of claim 12, wherein the bump guard is a circular disc.

14. The bearing assembly of claim 12, wherein the bump guard is fixed to the grease cap with an adhesive.

15. The bearing assembly of claim 12, wherein the bump guard is fixed to the grease cap with a heat activated bond.

16. The bearing assembly of claim 12, wherein the bump guard is a non-metallic material.

17. The bearing assembly of claim 12, wherein the bump guard includes a channel, and further comprising a seal engaged with the channel.

18. The bearing assembly of claim 12, wherein the bump guard includes a seal extending radially outward from a circumference of the bump guard, the bump guard and the seal being monolithic.

19. The bearing assembly of claim 12, wherein the grease cap is spaced from the hub.

20. The bearing assembly of claim 12, wherein the bearing assembly includes an outer ring, the grease cap fixed to the outer ring.
